(19) United States
(12) Patent Application Publication
(10) Pub. No.: US 2011/0080446 A1
(43) Pub. Date: Apr. 7, 2011

(54) FLUID EJECTING APPARATUS

(75) Inventor: Takato HAYASHI, Minowa-machi (JP)

(73) Assignee: SEIKO EPSON CORPORATION, Tokyo (JP)

(21) Appl. No.: 12/897,943

(22) Filed: Oct. 5, 2010

(30) Foreign Application Priority Data
Oct. 7, 2009 (JP) 2009-233588

(51) Int. Cl. B41J 2/165

(52) U.S. Cl. 347/31

(57) ABSTRACT

Provided is a fluid ejecting apparatus including: a fluid ejecting head which includes a plurality of nozzle rows formed of arranged nozzles ejecting a fluid onto a medium; linear fluid absorbing members which extend along the nozzle row, which are fewer in number than the nozzle rows, and which are disposed between the medium and the fluid ejecting head so as to absorb the fluid; and a movement mechanism which moves the fluid absorbing member to a position opposite the nozzle row by moving the fluid absorbing member relative to the fluid ejecting head.

### CROSS REFERENCES TO RELATED APPLICATIONS

The entire disclosure of Japanese Patent Application No. 2009-233588, filed Oct. 7, 2009, is expressly incorporated by reference herein.

### BACKGROUND

1. Technical Field

The present invention relates to a fluid ejecting apparatus.

2. Related Art

An ink jet printer (hereinafter, referred to as “a printer”) is widely known as a fluid ejecting apparatus which ejects ink droplets onto a printing sheet (medium). In this kind of printer, since ink evaporates from a nozzle of a printing head, ink in the nozzle is thickened or solidified, dust is attached to the nozzle, and bubbles are mixed with the ink in the nozzle, which causes an erroneous printing process. Therefore, generally, in a printer, in addition to an ejection operation of ejecting ink to a printing sheet, a flushing process of compulsorily ejecting ink in the nozzle to the outside is performed.

In a scanning-type printer, the flushing process is performed by moving a printing head to an area other than a printing area. However, in a printer including a line head in which a printing head is fixed, the printing head cannot move during a flushing process. Therefore, for example, JP-A-2005-119284 proposes a method of ejecting ink toward absorbing members provided in a surface of a sheet transporting belt.

However, in the method disclosed in JP-A-2005-119284, since the plural absorbing members are arranged at the same interval on the sheet transporting belt in accordance with the size of the printing sheet, problems arise in that ink needs to be ejected in every gap between the printing sheets during the flushing process, and in that the size or transporting speed of the printing sheet is limited. In addition, when the flushing process is performed on a planar absorbing member, ink is scattered in the form of a mist due to a wind pressure caused by an operation of ejecting ink droplets, which may contaminate the printing sheet or the sheet transporting belt.

Therefore, a fluid ejecting apparatus is proposed in which linear absorbing members requiring a small installation space or movement amount are prepared in a number equal to the number of nozzle rows, and each absorbing member is disposed directly below each nozzle row to perform a flushing process on the nozzle row. In this fluid ejecting apparatus, the flying of ink can be suppressed by using the linear absorbing member, and the time taken for the flushing process can be shortened by disposing the absorbing member between a printing head (fluid ejecting head) and a transportation area of a printing sheet during a printing process.

However, since the linear absorbing members are installed in a number equal to the number of nozzle rows, when all the absorbing members are disposed between the printing head and the transportation area of the printing sheet during a printing process, there is a concern that a jam may occur due to the interference between the printing sheet and the absorbing member during the transportation.

In addition, since the ink absorption amount of the linear absorbing member is limited, maintenance such as an exchange is required. At this time, since it is necessary to perform maintenance for more absorbing members in accordance with an increase in the number of linear absorbing members, the maintenance performance is degraded.

### SUMMARY

An advantage of some aspects of the invention is that it provides a fluid ejecting apparatus capable of suppressing the occurrence of a jam and improving a maintenance performance while using a linear fluid absorbing member.

An aspect of the invention provides a fluid ejecting apparatus including: a fluid ejecting head which includes a plurality of nozzle rows formed of arranged nozzles ejecting a fluid onto a medium; linear fluid absorbing members which extend along the nozzle row, which are fewer in number than the nozzle rows, and which is disposed between the medium and the fluid ejecting head so as to absorb the fluid; and a movement mechanism which moves the fluid absorbing members to a position opposite the nozzle row by moving the fluid absorbing members relative to the fluid ejecting head.

According to the fluid ejecting apparatus with such a configuration, the number of linear fluid absorbing members is less than the number of nozzle rows. For this reason, even when the fluid absorbing member is disposed between the printing head (fluid ejecting head) and the transportation area of the medium, it is possible to suppress the occurrence of jams compared with the case where the number of nozzle rows is equal to the number of fluid absorbing members.

Further, according to the fluid ejecting apparatus, since, compared with the case of using a number of fluid absorbing members that is equal to the number of nozzle rows, the number of fluid absorbing members that are maintenance targets is small, the maintenance performance is improved.

Likewise, according to the fluid ejecting apparatus, it is possible to suppress the occurrence of jams and to improve the maintenance performance while using the linear fluid absorbing member.

In the fluid ejecting apparatus, the size of the fluid absorbing member may be 15 to 50 times the size of the nozzle.

According to the fluid ejecting apparatus with such a configuration, since the fluid absorbing member can be disposed between the fluid ejecting head and the medium, the ejected ink can be captured by the fluid absorbing member even when component errors are considered.

In the fluid ejecting apparatus, the movement mechanism may move the fluid absorbing member to the position opposite the nozzle at a timing when the medium, onto which the fluid is ejected from the nozzle, is not opposite the nozzle.

According to the fluid ejecting apparatus with such a configuration, the fluid absorbing member is moved to the position opposite the nozzle at the timing when the medium is not positioned directly below the nozzle (for example, the timing when a gap between the mediums exists directly below the nozzle). For this reason, since the flushing process is performed at the timing when the medium is not positioned opposite the nozzle, it is possible to shorten or remove the time that the transportation of the medium is stopped due to the flushing process.

In the fluid ejecting apparatus, the movement mechanism may move the fluid absorbing member relative to the nozzle row so that a difference in the time for moving the fluid absorbing member to the position opposite the respective nozzle rows is minimal.

According to the fluid ejecting apparatus with such a configuration, since a difference in the time for moving the fluid absorbing member to the positions opposite the respective nozzle rows is minimal, it is possible to make the time for the flushing processes of the respective nozzle rows substantially uniform, and thus to make the frequencies of the flushing processes of the respective nozzle rows uniform.

In the fluid ejecting apparatus, the fluid ejecting apparatus may further include a second movement mechanism which moves the fluid absorbing member along the extension direction of the nozzle row.

According to the fluid ejecting apparatus with such a configuration, since the fluid absorbing member is moved along the extension direction of the nozzle row, it is possible to absorb the fluid in the other area of the fluid absorbing member.

For this reason, since it is possible to absorb the fluid in the entire area of the fluid absorbing member, it is possible to use the fluid absorbing member for a longer period of time.

In the fluid ejecting apparatus, the second movement mechanism may include a detachable rotation portion around which the fluid absorbing member is wound.

According to the fluid ejecting apparatus with such a configuration, it is possible to easily exchange the fluid absorbing member by exchanging the rotation portion around which the fluid absorbing member is wound.

In the fluid ejecting apparatus, the second movement mechanism may move the fluid absorbing member after the fluid is ejected from the other nozzle to the same area of the fluid absorbing member.

According to the fluid ejecting apparatus with such a configuration, the fluid absorbing member is moved after the same area of the fluid absorbing member absorbs the fluid a plurality of times. For this reason, since it is possible to absorb a large amount of the fluid by using the fluid absorbing member, it is possible to use the fluid absorbing member for a longer period of time.

In the fluid ejecting apparatus, the number of fluid absorbing members may be one.

According to the fluid ejecting apparatus with such a configuration, since the number of fluid absorbing members is suppressed to be minimal, it is possible to further suppress the occurrence of jams, and to further improve the maintenance performance.

### BRIEF DESCRIPTION OF THE DRAWINGS

The invention will be described with reference to the accompanying drawings, wherein like numbers reference like elements.

FIG. 1 is a perspective view illustrating a schematic configuration of a printer of the first embodiment of the invention.

FIG. 2 is a perspective view illustrating a lower surface side of a head unit provided in the printer of the first embodiment of the invention.

FIG. 3 is a perspective view illustrating the head unit and the flushing unit provided in the printer of the first embodiment of the invention when seen from the lower side thereof.

FIG. 4 is a schematic diagram illustrating the head unit and the flushing unit provided in the printer of the first embodiment of the invention when seen from the transportation direction of the printing sheet.

FIGS. 5A and 5B are schematic diagrams illustrating an example of an absorbing member provided in the printer of the first embodiment of the invention.

FIGS. 6A to 6D are explanatory diagrams illustrating the flushing position of the printer of the first embodiment of the invention.

FIGS. 7A to 7D are explanatory diagrams illustrating the retreat position of the printer of the first embodiment of the invention.

FIG. 8 is a schematic diagram illustrating a modified example of the printing head of the printer of the first embodiment of the invention.

### DESCRIPTION OF EXEMPLARY EMBODIMENTS

Hereinafter, an embodiment of a fluid ejecting apparatus according to the invention will be described with reference to the accompanying drawings. Further, in the drawings below, the scales of the respective members are appropriately changed so that the respective members have recognizable sizes. Furthermore, in the description below, an ink jet printer (hereinafter, simply referred to as a printer) as an example of the fluid ejecting apparatus of the invention will be described.

### First Embodiment

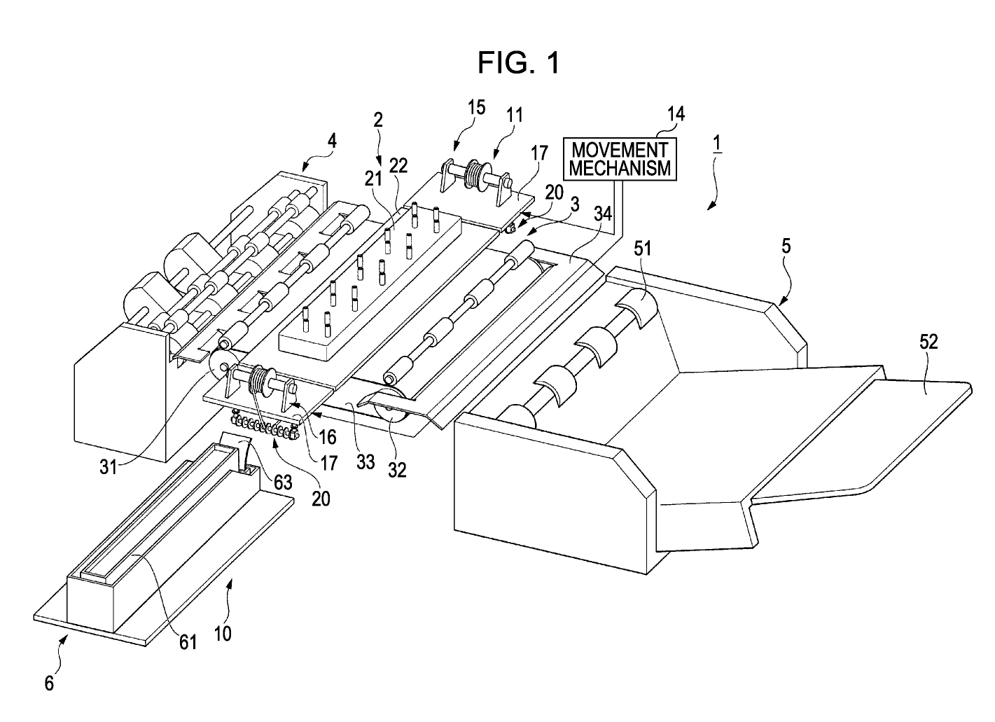

FIG. 1 is a perspective view illustrating a schematic configuration of a printer 1 of this embodiment of the invention. As illustrated in this drawing, the printer 1 of this embodiment includes a head unit 2, a transportation device 3 which transports a printing sheet (medium), a sheet feeding unit 4 which supplies the printing sheet, a sheet discharging unit 5 which discharges the printing sheet printed by the head unit 2, and a maintenance device 10 which performs a maintenance process on the head unit 2.

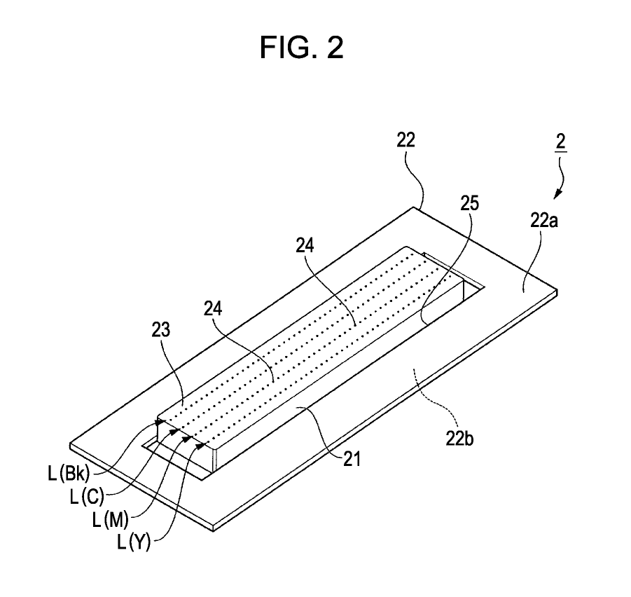

The transportation device 3 holds the printing sheet while having a predetermined gap with respect to a nozzle surface 23 (refer to FIG. 2) of a printing head 21 constituting the head unit 2. The transportation device 3 includes a driving roller portion 31, a driven roller portion 32, and a transporting belt portion 33 which is formed by a plurality of belts wound around the roller portions 31 and 32. In addition, a holding member 34 for holding the printing sheet is installed between the sheet discharging unit 5 and the downstream side (the side of the sheet discharging unit 5) of the transportation direction of the printing sheet of the transportation device 3.

One end of the driving roller portion 31 in the rotation direction is connected to a driving motor (not shown), and is rotationally driven by the driving motor. The rotation force of the driving roller portion 31 is transmitted to the transporting belt portion 33, so that the transporting belt portion 33 is rotationally driven. If necessary, a transmission gear is provided between the driving roller portion 31 and the driving motor. The driven roller portion 32 is a so-called free roller which supports the transporting belt portion 33 and is rotated by the rotational driving operation of the transporting belt portion 33 (the driving roller portion 31).

The sheet discharging unit 5 includes a sheet discharging roller 51 and a sheet discharging tray 52 which holds the printing sheet transported by the sheet discharging roller 51.

FIG. 2 is a perspective view illustrating the lower surface side of the head unit 2. As illustrated in this drawing, the head unit 2 includes a linear printing head 21 (fluid ejecting head) and an attachment plate 22 supporting the printing head 21.

The printing head 21 is formed in accordance with the effective printing width of the head unit 2, and includes a plurality of nozzles 24 ejecting ink. In addition, the nozzles 24 ejecting the same kind (for example, black B, magenta M, yellow Y, and cyan C) of ink are arranged in the extension direction of the printing head 21 to thereby form one nozzle row L. That is, the printer 1 of this embodiment includes the printing head 21 having nozzle rows L formed of the plurality of nozzles 24 ejecting ink.

In more detail, the printing head 21 has four nozzle rows (L(Y), L(M), L(C), and L(Bk)) corresponding to four colors (yellow (Y), magenta (M), cyan (C), and black (Bk)). As for each of the nozzle rows (L(Y), L(M), L(C), and L(Bk)), the nozzles 24 forming the corresponding nozzle rows (L(Y), L(M), L(C), and L(Bk)) are arranged in the horizontal direction intersecting the transportation direction of the printing sheet, and are more desirably arranged in the horizontal direction perpendicular to the transportation direction of the printing sheet.

As illustrated in FIG. 2, the head unit 2 has a structure in which the printing head 21 is disposed inside an opening 25 formed in the attachment plate 22. In detail, the printing head 21 is fixed to a rear surface 22b of the attachment plate 22 by the use of a screw, so that the nozzle surface 23 protrudes from a front surface 22a of the attachment plate 22 via the opening 25. In addition, since the attachment plate 22 is fixed to a carriage (not shown), the head unit 2 is adapted to be movable to a maintenance position to be described later.

The head unit 2 of this embodiment is adapted to be movable between the printing position and the maintenance position by the use of a carriage (not shown). Here, the printing position is a position where the head unit performs a printing process on the printing sheet while facing the transportation device 3. On the other hand, the maintenance position is a position where the head unit faces a cap unit 6 (refer to FIG. 1) provided in the maintenance device 10 at a position retreating from the upper side of the transportation device 3. The maintenance process (a suction process and a wiping process) for the head unit 2 is performed at the maintenance position.

Returning to FIG. 1, the maintenance device 10 includes the cap unit 6 which performs the suction process on the head unit 2, and a flushing unit 11 which performs a flushing process on the head unit 2.

The cap unit 6 performs the maintenance process such as a capping or suction operation on the head unit 2, and includes a cap portion 61 corresponding to the printing head 21. The cap unit 6 is disposed at a position deviated from a printing area of the head unit 2.

The cap portion 61 is adapted to come into contact with the nozzle surface 23 of the printing head 21. Since the cap portion 61 comes into close contact with the nozzle surface 23 of the printing head 21, it is possible to perform a satisfactory capping operation, and also to perform a satisfactory suction operation of discharging ink from the nozzle surface 23.

In addition, as illustrated in FIG. 1, the cap unit 6 includes a wiper member 63 which is used in a wiping process of wiping the nozzle surface 23 of the printing head 21.

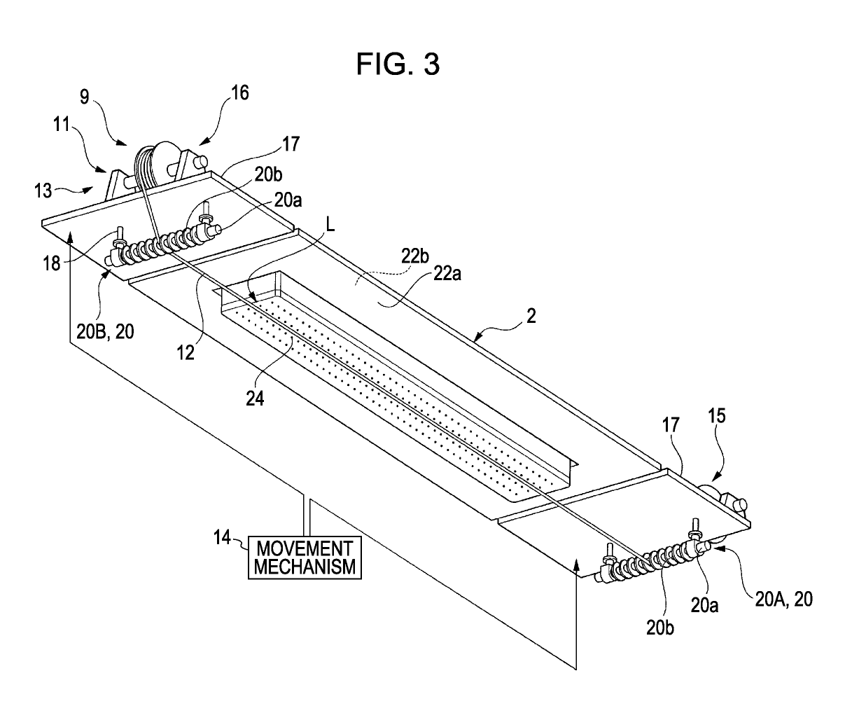

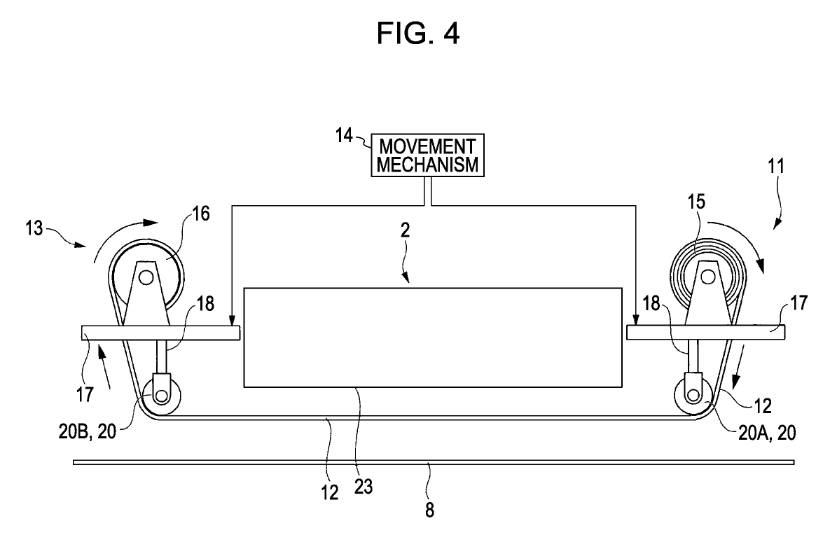

FIG. 3 is a perspective view illustrating the head unit 2 and the flushing unit 11 when seen from the lower side thereof. In addition, FIG. 4 is a schematic diagram illustrating the head unit 2 and the flushing unit 11 when seen from the transportation direction of the printing sheet.

As illustrated in the drawings, the flushing unit 11 includes an absorbing member 12 (fluid absorbing member) absorbing ink ejected during the flushing process and a support mechanism 9 supporting the absorbing member 12.

The absorbing member 12 is a linear member that absorbs the ink ejected from each nozzle 24, and extends along the nozzle rows (L(Y), L(M), L(C), and L(Bk)) constituted by the nozzles 24 of respective colors while being located between the nozzle surface 23 and the transportation area of the printing sheet.

Further, the printer 1 of this embodiment is provided with only one absorbing member 12. That is, the number of absorbing members 12 is smaller than the number of nozzle rows L.

Next, the detailed configuration of the absorbing member 12 suitably used in the printer 1 according to this embodiment will be described.

For example, the absorbing member 12 may be formed of fiber such as SUS 304, nylon, nylon applied with a hydrophobic coating, aramid, silk, cotton, polyester, ultrahigh molecular weight polyethylene, polyarylate, or Zylon (product name), or compound fiber containing a plurality of these.

In more detail, it is possible to form the absorbing member 12 in such a manner that plural fiber bundles formed of the fiber or the compound fiber are twisted or bound.

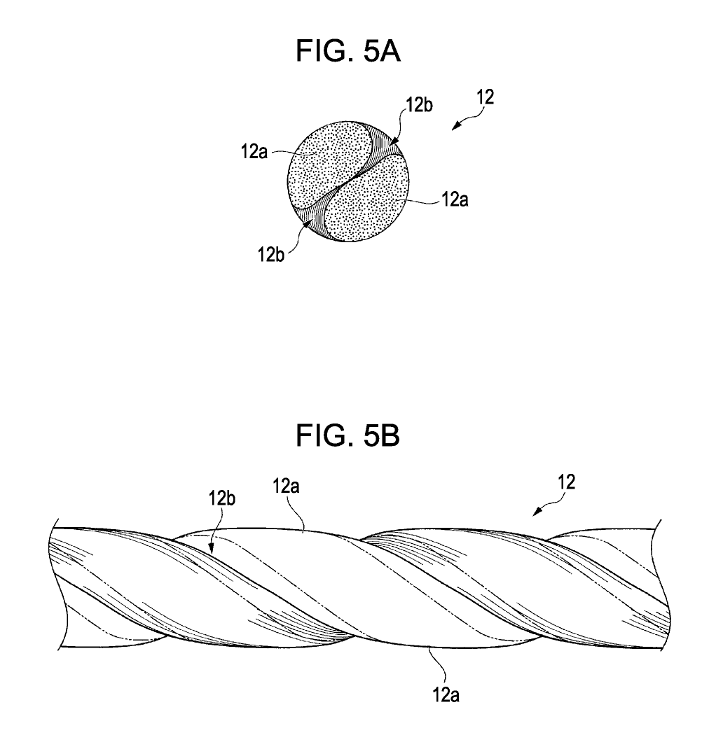

FIGS. 5A and 5B are schematic diagrams showing an example of the absorbing member 12, where FIG. 5A is a sectional view and FIG. 5B is a plan view. As shown in FIGS. 5A and 5B, for example, the absorbing member 12 is formed in such a manner that two (plural) fiber bundles (strings) 12a formed of fiber are twisted. As shown in FIGS. 5A and 5B, in the case where the absorbing member 12 is formed by twisting the plural fiber bundles 12a, since it is possible to store ink in a valley portion 12b formed between the fiber bundles 12a, it is possible to increase an ink absorption amount of the absorbing member 12.

In addition, as an example, a linear member obtained by twisting plural fiber bundles formed of SUS 304, a linear member obtained by twisting plural fiber bundles formed of nylon, a linear member obtained by twisting plural fiber bundles formed of nylon applied with hydrophobic coating, a linear member obtained by twisting plural fiber bundles formed of aramid, a linear member obtained by twisting plural fiber bundles formed of silk, a linear member obtained by twisting plural fiber bundles formed of cotton, a linear member obtained by twisting plural fiber bundles formed of Belima (product name), a linear member obtained by twisting plural fiber bundles formed of Soierion (product name), a linear member obtained by twisting plural fiber bundles formed of Hamilon 03 T (product name), a linear member obtained by twisting plural fiber bundles formed of Dyneema hamilon DB-8 (product name), a linear member obtained by twisting plural fiber bundles formed of Vectran hamilon VB-30, a linear member obtained by twisting plural fiber bundles formed of Hamilon S-5 Core Kevlar Sleeve Polyester (product name), a linear member obtained by twisting plural fiber bundles formed of Hamilon S-212 Core Coupler Sleeve Polyester (product name), a linear member obtained by twisting plural fiber bundles formed of Hamilon SZ-10 Core Zylon Sleeve Polyester (product name), or a linear member obtained by twisting plural fiber bundles formed of Hamilon VB-3 Vectran (product name) may be suitably used as the absorbing member 12.

Since the absorbing member 12 obtained by the fiber of nylon is formed of nylon widely used as a general leveling string, the absorbing member 12 is cheap.

Since the absorbing member 12 using the metallic fiber of SUS has an excellent corrosion resistance property, it is possible to allow the absorbing member 12 to absorb a variety of ink. Also, since the absorbing member 12 has an excellent wear resistance property compared with a resin, it is possible to repeatedly use the absorbing member 12.

The absorbing member 12 using the fiber of ultrahigh molecular weight polyethylene has high breaking strength and chemical resistance, and is strong against an organic solvent, acid, or alkali. Likewise, since the absorbing member 12 using the fiber of ultrahigh molecular weight polyethylene has high breaking strength, it is possible to pull the absorbing member 12 in a high-tension state, and to prevent the absorbing member 12 from being bent. For this reason, in the case where the diameter of the absorbing member 12 is thickened so as to increase the absorbing capacity or the diameter of the absorbing member 12 is not thickened, it is possible to improve the printing precision by narrowing the distance between the printing sheet transporting region and the head 21. In addition, it is expected that the above-described advantage is obtained even in the absorbing member 12 using the fiber of Zylon or an aramid and the absorbing member 12 using the fiber of super-high-molecular polyethylene.

The absorbing member 12 using the fiber of cotton has an excellent ink absorbing property.

In the absorbing member 12, the dropped ink is accommodated and absorbed in the valley portion 12b (see FIGS. 5A and 5B) formed between the fiber bundle 12a and the fiber due to the surface tension.

In addition, a part of the ink dropped onto the surface of the absorbing member 12 directly enters into the absorbing member 12, and the rest moves to the valley portion 12b formed between the fiber bundles 12a. Further, a part of the ink entering into the absorbing member 12 gradually moves in the extension direction of the absorbing member 12 in the inside of the absorbing member 12 so as to be held therein while being dispersed in the extension direction of the absorbing member 12. A part of the ink moving to the valley portion 12b of the absorbing member 12 gradually enters into the absorbing member 12 through the valley portion 12b, and the rest remains in the valley portion 12b so as to be held therein while being dispersed in the extension direction of the absorbing member 12. That is, a part of the ink dropped onto the surface of the absorbing member 12 stays at the dropped position, and the rest is dispersed and absorbed in the vicinity of the dropped position.

In addition, in fact, a material forming the absorbing member 12 provided in the printer 1 is selected in consideration of an ink absorbing property, an ink holding property, a tensile strength, an ink resistance property, formability (a generated amount of fluff or fraying), distortion, cost, or the like.

Further, the ink absorbing amount of the absorbing member 12 is the sum of the amount of ink held between the fibers of the absorbing member 12 and the amount of ink held in the valley portion 12b. For this reason, the material forming the absorbing member 12 is selected so that the ink absorbing amount is sufficiently larger than the amount of the ink ejected during the flushing process in consideration of the exchange frequency of the absorbing member 12.

Furthermore, the amount of ink held between the fibers of the absorbing member 12 and the amount of ink held in the valley portion 12b may be determined by the contact angle between the ink and the fibers, and the capillary force between the fibers depending on the surface tension of the ink. That is, when the absorbing member 12 is formed of thin fibers, the gap between the fibers increases and the surface area of the fiber increases. Accordingly, even when the sectional area of the absorbing member 12 is uniform, the absorbing member 12 is capable of absorbing a larger amount of ink. As a result, in order to obtain more gaps between the fibers, a micro fiber (ultrafine fiber) may be used as a fiber forming the fiber bundle 12a.

However, the ink holding force of the absorbing member 12 decreases since the capillary force decreases due to an increase in the gap between the fibers. For this reason, it is necessary to set the gap between the fibers so that the ink holding force of the absorbing member 12 is of a degree that the ink is not dropped due to the movement of the absorbing member 12.

In addition, the thickness of the absorbing member 12 is set so as to satisfy the above-described ink absorbing amount. In detail, for example, the thickness of the absorbing member 12 is set to be equal to or more than 0.3 mm and equal to or less than 1.0 mm, and more desirably about 0.5 mm.

However, in order to prevent the absorbing member 12 from coming into contact with the head 21 and the printing sheet, the thickness of the absorbing member 12 is set so that the maximum dimension of the section is equal to or less than a dimension obtained by subtracting an amount excluding the displacement amount caused by the bending of the absorbing member 12 from the distance of the sheet transporting region between the printing sheet and the head 21.

In addition, the absorbing member 12 has a width which is 15 to 50 times larger than the diameter of the nozzle. In this embodiment, the gap between the printing sheet and the nozzle surface 23 of the printing head 21 is about 2 mm, and the nozzle diameter is about 0.02 mm. Accordingly, when the diameter of the absorbing member 12 is 1 mm or less, the absorbing member can be disposed between the nozzle surface and the printing sheet, and the ejected ink can be captured by the absorbing member even when component error is considered.

In addition, it is desirable that the length of the absorbing member 12 is sufficiently long with respect to the effective printing width of the head unit 2. As described later in detail, in the printer 1 of this embodiment, when the ink is absorbed to the entire area of the absorbing member 12 in a manner in which the used-up area (which cannot absorb the ink any more) of the absorbing member 12 is sequentially wound, the absorbing member 12 is exchanged with a new one. For this reason, the exchange period of the absorbing member 12 needs to be set to the time that the absorbing member can be used in the practical application, and desirably the length of the absorbing member 12 needs to be roughly several hundreds of times longer than the effective printing width of the head unit 2. However, when the absorbing member 12 is recycled by the cleaning process inside the printer 1, the length of the absorbing member 12 may be slightly longer than about twice the effective printing width of the head unit 2.

Then, the absorbing member 12 is supported by the support mechanism 9.

As illustrated in FIGS. 3 and 4, the support mechanism 9 includes a movement mechanism 13 and a movement mechanism 14.

The movement mechanism 14 moves the absorbing member 12 between the flushing position opposite the nozzle 24 and the retreat position not opposite the nozzle 24 by moving the absorbing member 12 in the direction (in this embodiment, perpendicular to) intersecting the extension direction of the nozzle row. In addition, the movement mechanism 13 moves the absorbing member 12 to flow along the extension direction of the nozzle row.

As illustrated in FIGS. 3 and 4, the movement mechanism 13 includes rotation portions 15 and 16 which are respectively provided in both sides of the head unit 2 in the nozzle arrangement direction to be fixed to the side of the rear surface 22b (the opposite side of the nozzle surface 23 of the printing head 21) of the attachment plate 22 so that their rotation shafts are parallel to the transportation direction of the printing sheet. The rotation portions 15 and 16 constitute a winding mechanism which is formed in a bobbin shape with a plurality of partition plates arranged at the same interval, where one absorbing member 12 is wound between the partition plates.

Then, the rotation portions 15 and 16 are installed on the support plate 17 installed inside the casing of the printer 1.

The rotation portions 15 and 16 are connected to a driving motor (not shown), and the absorbing member 12 is supplied and wound by the rotation thereof. In this embodiment, one rotation portion 15 is used to supply the absorbing member 12 therefrom, and the other rotation portion 16 is used to wind the absorbing member 12 thereon. In addition, the rotation portions 15 and 16 are detachable from the support plate 17.

The movement mechanism 14 moves the absorbing member 12 of the rotation portions 15 and 16 in the transportation direction of the printing sheet (the direction perpendicular to the extension direction of the nozzle row) by moving the support plate 17 in the transportation direction of the printing sheet while supporting the support plate 17. An example of the movement mechanism 14 includes a linear slide device.

In addition, the support mechanism 9 includes a pulley 20 which is axially supported to the rear surface (the surface opposite to the surface provided with the rotation portions 15 and 16) of the support plate 17.

The pulley 20 has a structure in which a convex portion 20b is wound around a shaft portion 20a in a coil shape, and is installed for each support plate 17 (pulleys 20A and 20B). Then, the absorbing member 12 is held inside a guide groove formed of the shaft portion 20a and the convex portion 20b.

Then, as illustrated in FIGS. 3 and 4, the pulleys 20A and 20B are installed on the support plate 17 via shaft support portions 18, and are disposed on both sides of the head unit 2 in the nozzle arrangement direction to be fixed to the side of the front surface 22a of the attachment plate (the nozzle surface 23 of the printing head 21). The absorbing members 12 wound and suspended on the rotation portions 15 and 16 of the movement mechanism 13 are bridged between the pulleys 20A and 20B. Then, the end of the guide groove 20c in the direction perpendicular to the nozzle surface 23 is located in a direction moving away from the nozzle surface 23 with respect to the nozzle surface 23. For this reason, the absorbing member 12 bridged between the pulleys 20A and 20B is held without contacting the nozzle surface 23 of the printing head 21.

In addition, the support mechanism 9 holds the absorbing member 12 at appropriate tension not curving the absorbing member in a manner in which the rotation speeds of the rotation portions 15 and 16 are respectively controlled by a control device (not shown). Accordingly, it is possible to prevent the absorbing member 12 from being curved to contact the nozzle surface 23 or the printing sheet.

In such a support mechanism 9, since the plurality of absorbing members 12 is supported by the rotation portions 15 and 16 disposed on the support plate 17 and the pulleys 20A and 20B disposed on the front surface 22a of the attachment plate 22, the absorbing member 12 is supplied from the rotation portion 15, and is wound around the rotation portion 16 while passing on the nozzle surface 23 of the printing head 21. For this reason, the absorbing member 12 is moved in the extension direction of each nozzle row L of the head unit 2, that is, the direction intersecting the transportation direction of the printing sheet in accordance with the rotation of the rotation portions 15 and 16.

In addition, since the support plate 17 is moved in the transportation direction of the printing sheet by the movement mechanism 14, it is possible to change the position of the absorbing member 12 with respect to the head unit 2 (nozzle row L). Specifically, in this embodiment, the absorbing member 12 is moved between the flushing position and the retreat (printing) position.

Further, if the diameter of the absorbing member 12 is set to 1 mm, the absorbing member 12 can be located to avoid the flying path of the ink on the outside even when the absorbing member is moved by 1 mm under the condition that there are component dimension errors or arrangement errors. For this reason, the time taken for the movement of the absorbing member 12 may be shortened. In addition, since the distance between the printing head 21 and the printing sheet is 2 mm, and the absorbing member 12 is disposed in a tensioned state, the printing head 21 and the printing sheet do not need to be moved during the movement of the support plate 17 using the movement mechanism 14.

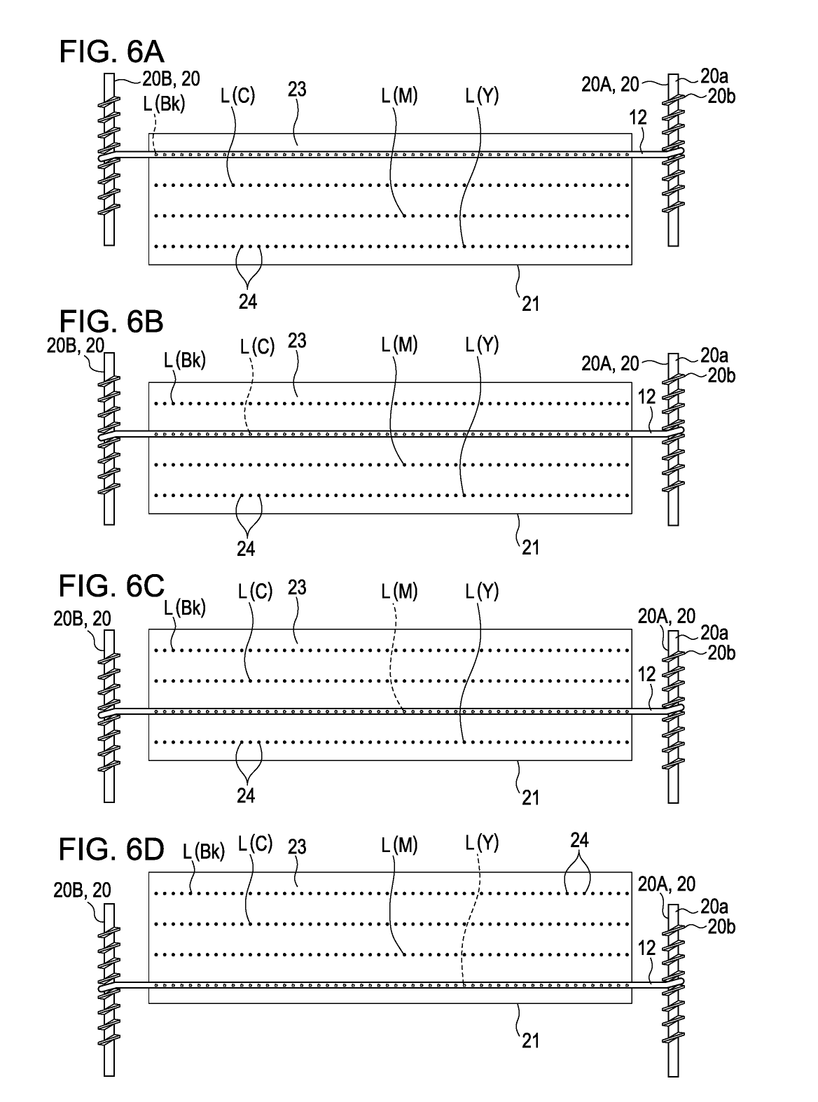

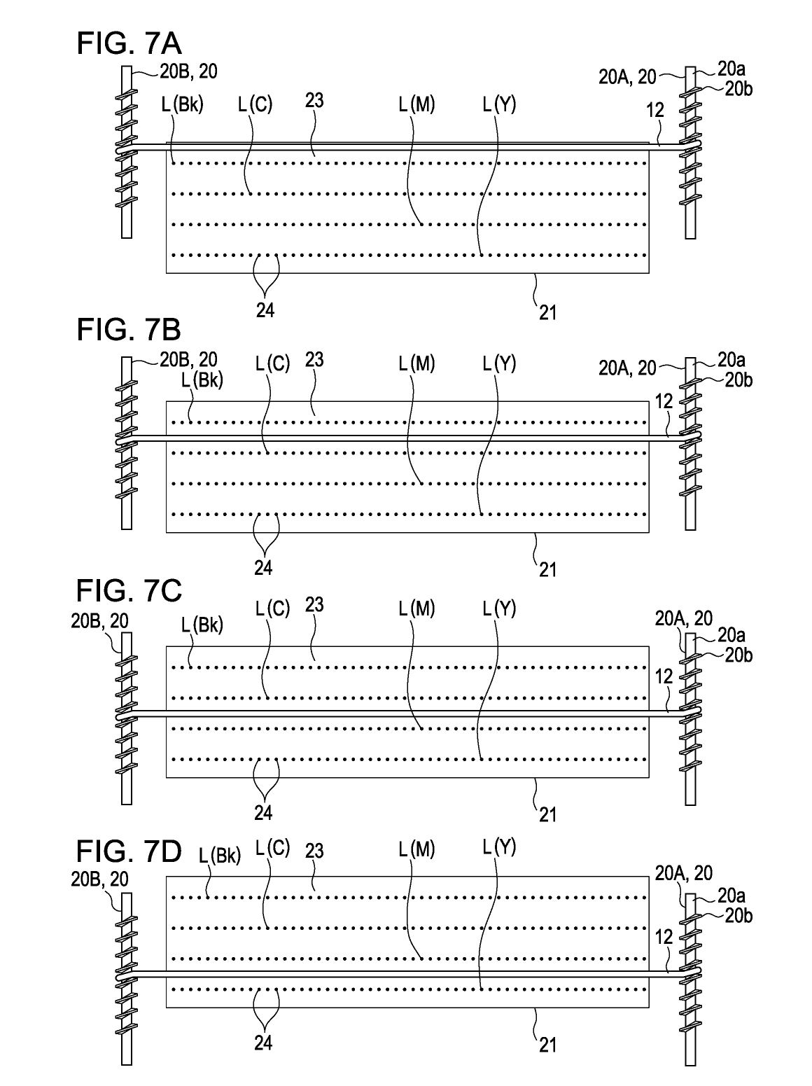

Further, as illustrated in FIGS. 6A to 6D, the flushing position indicates a position (a position on the flying path of the ink) where the inks ejected from the nozzle rows L during the flushing process can be absorbed by the absorbing member 12 in the state where the absorbing member is disposed directly below each of the nozzle rows L (the plurality of nozzles 24 constituting the nozzle rows L). On the other hand, as illustrated in FIGS. 7A to 7D, the retreat position of the absorbing member 12 indicates a position where the inks ejected from the nozzles 24 during the printing process cannot be absorbed by the absorbing member 12 in the state where the absorbing member does not face the nozzle rows L (the plurality of nozzles 24 constituting the nozzle rows L).

When the support plate 17 and the pulley 20 are moved by the movement mechanism 14, as illustrated in FIGS. 6A to 6D and 7A to 7D, the absorbing member 12 is moved to the flushing position and the retreat position. Then, the absorbing member 12 of the printer 1 of this embodiment is disposed between the printing sheet and the nozzle surface of the printing head 21 in the transportation direction of the printing sheet not only at the flushing position, but also at the retreat position.

In the printer 1 according to this embodiment, all processes are generally controlled by a control device (not shown), and the flushing process is performed at the time between the printing processes, that is, at the time when a gap between the printing sheets sequentially transported by the transportation device 3 is located directly below the printing head 21.

That is, the movement mechanism 14 of the printer 1 of this embodiment moves the absorbing member 12 at the timing when the printing sheet 8, onto which the ink is ejected from the nozzle 24, is not positioned directly below the nozzle 24 so as to be located directly below the nozzle 24.

Specifically, for example, when a gap between the printing sheets 8 reaches a position below the printing head 21 while the absorbing member 12 is disposed at the retreat position shown in FIG. 7A during the printing process, the movement mechanism 14 moves the absorbing member 12 to the flushing position directly below the nozzle row L(Bk) as shown in FIG. 6A.

When the absorbing member 12 moves to the flushing position directly below the nozzle row L(Bk), the control device performs the flushing process by ejecting ink from the nozzle 24 constituting the nozzle row L(Bk).

Subsequently, as illustrated in FIG. 6B, the movement mechanism 14 moves the absorbing member 12 to the flushing position directly below the nozzle row L(C). Then, the control device performs the flushing process by ejecting ink from the nozzle 24 constituting the nozzle row L(C).

Subsequently, as illustrated in FIG. 6C, the movement mechanism 14 moves the absorbing member 12 to the flushing position directly below the nozzle row L(M). Then, the control device performs the flushing process by ejecting ink from the nozzle 24 constituting the nozzle row L(M).

Subsequently, as illustrated in FIG. 6D, the movement mechanism 14 moves the absorbing member 12 to the flushing position directly below the nozzle row L(Y). Then, the control device performs the flushing process by ejecting ink from the nozzle 24 constituting the nozzle row L(Y).

Then, when the flushing process for all nozzle rows L is completed, the movement mechanism 14 moves again the absorbing member 12 to the retreat position shown in FIG. 7A.

In addition, when all the flushing processes described above are completed during the time when the gaps between the printing sheets pass through a position below the printing head 21 while the printing sheets are continuously transported by the transportation device 3, the control device continuously transports the printing sheet using the transportation device 3 during the flushing process, and resumes the printing process when the next printing sheet is located at a position below the printing head 21.

On the other hand, when all the flushing processes described above are not completed during the time when the gap between the printing sheets passes through a position below the printing head 21, the control device first stops the transportation of the printing sheet using the transportation device 3 until the flushing process is completed.

Further, of course, it is desirable that the flushing process is completed without stopping the transportation of the printing sheet using the transportation device 3.

For this reason, when it is difficult to complete the flushing process for all nozzle rows L during the time corresponding to a gap between the printing sheets without stopping the transportation of the printing sheet using the transportation device 3, it is desirable that the flushing process is performed during the time corresponding to plural gaps between the printing sheets.

Accordingly, the flushing process can be completed without stopping the transportation of the printing sheet using the transportation device 3.

In addition, it is desirable that the frequencies of the flushing processes for the respective nozzle rows L are equal to each other. For this reason, it is desirable that a difference in the time for moving the absorbing member 12 to the positions directly below the respective nozzle rows L is minimal (preferably zero).

For example, in the printer 1 of this embodiment, when the absorbing member 12 is moved in an order of FIG. 7A, 7C, 7D, 7B, 7A, . . . , it is possible to make a difference in the time for moving the absorbing member 12 to the positions directly below the respective nozzle rows L minimal.

Accordingly, since it is possible to make the time for the flushing processes of the respective nozzle rows L substantially uniform, it is possible to make the frequencies of the flushing processes of the respective nozzle rows L uniform.

Further, the control device performs a winding operation of winding a portion having ink absorbed thereto of the absorbing member 12 in such a manner that a movement mechanism 13 is driven to move the absorbing member 12 during the flushing process. Accordingly, since the ink ejected from the nozzle row L is normally ejected to a new portion not having ink absorbed thereto of the absorbing member 12, the ink is rapidly absorbed to the absorbing member 12.

The winding speed of winding the absorbing member 12 using the movement mechanism 13 is adjusted in accordance with the ejection amount of the ink. That is, when a large amount of ink is ejected, it is desirable that the winding speed is increased to a high speed so that the absorbing member 12 is not saturated and ink absorption omission does not occur.

Further, since the entire area of the absorbing member 12 can receive the ink by winding the absorbing member 12 using the movement mechanism 13, it is possible to use the absorbing member 12 for a longer period of time without exchanging the absorbing member 12 with new one.

Furthermore, the winding operation using the movement mechanism 13 may be performed after the flushing process is completed and the absorbing member 12 is moved to the retreat position by the movement mechanism 14.

Moreover, the winding operation of winding the absorbing member 12 may be performed by driving the movement mechanism 13 even when the flushing process is not performed.

Accordingly, the ink can be absorbed to an area, which has not absorbed any ink, of the absorbing member 12 at the next flushing process.

In addition, when the maximum section dimension of the absorbing member 12 can be ensured with respect to the nozzle diameter, the ink absorption amount of the absorbing member 12 becomes large. For this reason, the winding operation of the absorbing member 12 may not be performed during the flushing process. For example, if the ink does not drip even when ink corresponding to 100 droplets is ejected to the same position of the absorbing member 12, the absorbing member 12 may be wound after the flushing process is performed 10 times.

That is, in the printer 1 of this embodiment, the absorbing member 12 may be moved along the extension direction of the nozzle row L after ink is ejected from another nozzle 24 (the nozzle 24 constituting another nozzle row L) to the same area of the absorbing member 12.

Accordingly, since the absorbing member 12 can absorb a large amount of ink, it is possible to use the absorbing member 12 for a longer period of time.

As described above, in the printer 1 of this embodiment, a configuration is adopted in which the printer includes the plurality of nozzle rows L that is arranged in a direction perpendicular to (intersecting) the arrangement direction of the nozzles 24, the linear absorbing members 12 that extend along the nozzle row L and are fewer in number than the nozzle rows L, and the movement mechanism 14 which moves the absorbing members 12 to the positions directly below the plurality of nozzle rows L.

That is, in the printer 1 of this embodiment, the number of absorbing members 12 is less than the number of nozzle rows L. For this reason, even when the absorbing member 12 is disposed between the printing head 21 and the transportation area of the printing sheet 8, it is possible to suppress the occurrence of jams compared with the case where the number of nozzle rows L is equal to the number of absorbing members 12.

Further, according to the printer 1 of this embodiment, since the number of absorbing members 12 as the maintenance targets is few compared with the case where the number of nozzle rows L is equal to the number of absorbing members 12, maintenance performance is improved.

Likewise, according to the printer 1 of this embodiment, it is possible to suppress the occurrence of jams and to improve the maintenance performance while using the linear absorbing member 12.

In addition, the movement mechanism 14 of the printer 1 of this embodiment is adapted to move the absorbing member 12 to a position directly below the nozzle 24 at the timing when the printing sheet 8, onto which the ink is ejected from the nozzle 24, is not positioned directly below the nozzle 24.

For this reason, since the flushing process is performed at the timing when the printing sheet 8 is not positioned directly below the nozzle 24, it is possible to shorten or remove the time that the transportation of the printing sheet 8 is stopped due to the flushing process.

Further, the movement mechanism 13 of the printer 1 of this embodiment includes the detachable rotation portions 15 and 16 around which the absorbing member 12 is wound.

For this reason, it is possible to easily exchange the absorbing member 12 by exchanging the rotation portions 15 and 16 around which the absorbing member 12 is wound.

Furthermore, in the printer 1 of this embodiment, the number of absorbing members 12 is only one.

For this reason, since the number of absorbing members 12 is suppressed to be minimal, it is possible to further suppress the occurrence of jams, and to further improve the maintenance performance.

While the preferred embodiments of the invention are described as above with reference to the accompanying drawings, it is needless to say that the invention is not limited to the preferred embodiments, and the preferred embodiments may be combined with each other. It is apparent that various modifications and corrections can be made by persons skilled in the art within the scope of the technical spirit according to the claims, and it should be, of course, understood that the modifications and corrections are included in the technical scope of the invention.

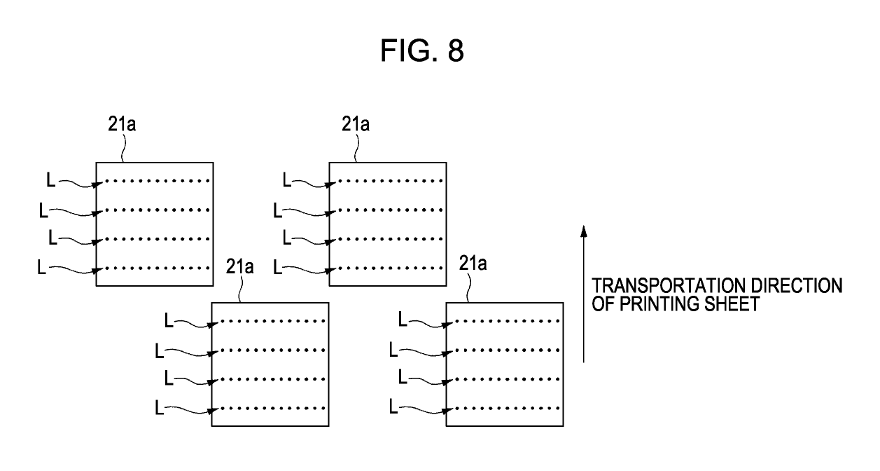

For example, in the above-described embodiments, a configuration has been described in which a single line head is provided as the printing head 21. However, the invention is not limited thereto, and a plurality of heads may be arranged in accordance with the effective printing width. At this time, as illustrated in FIG. 8, a plurality of heads 21a may not be arranged in series, but may be arranged in a zigzag as a whole.

Likewise, when the plurality of heads 21a is disposed in zigzag, a plurality of nozzle rows is disposed at the same position in the arrangement direction of the nozzle rows (the transportation direction of the printing sheet). However, the flushing process can be performed in accordance with the control of the above-described embodiments by making the plurality of nozzle rows disposed at the same position in the arrangement direction of the nozzle rows be one nozzle row during the flushing process.

Furthermore, a cleaning mechanism that cleans the absorbing member 12 may be installed in the printer of this embodiment. In this case, when the cleaning mechanism is disposed on the downstream side of the transportation direction of the absorbing member 12 (on the downstream side of the pulley 20B), a cleaning process of cleaning the absorbing member 12 absorbing the ink can be performed. Since the absorbing member 12, which can be used again due to the cleaning process, is wound around the rotation portion 16, the flushing process can be performed again by rotating, for example, the rotation portions 15 and 16 in the reverse direction.

In the above-described embodiments, the configuration is described in which the absorbing members 12 extend in parallel to the extension direction of the nozzle rows. However, the invention is not limited thereto, and the extension direction of the absorbing members 12 may not be perfectly parallel to the extension direction of the nozzle rows. That is, in the invention, the meaning that the absorbing members extend along the extension direction of the nozzle rows includes the case where the extension line extending in the extension direction of the nozzle rows intersects the extension line extending in the extension direction of the absorbing members in the front region as well as the case where the extension direction of the absorbing members is perfectly parallel to the extension direction of the nozzle rows.

In the above-described embodiments, a configuration is described in which the invention is applied to the line head type printer. However, the invention is not limited thereto, but may be applied to a serial type printer.

In the above-described embodiments, a configuration is described in which the absorbing members 12 always move right below the head 21. However, the invention is not limited thereto, but may adopt a configuration in which the absorbing members 12 move to a region (for example, a region on the side portions of the head 21) deviated from the positions right below the head 21 upon retracting the absorbing members 12.

In the above-described embodiments, a configuration is adopted in which a positional relationship between the absorbing members 12 and the head 21 is changed by moving the absorbing members 12. However, the invention is not limited thereto, but a configuration may be adopted in which a positional relationship between the absorbing members 12 and the head 21 is changed by moving the head 21.

In the above-described embodiments, a configuration is described in which the absorbing members 12 and 72 are located at the sheet transporting region between the printing sheet and the head 21. However, the invention is not limited thereto, but a configuration may be adopted in which the absorbing members 12 and 72 are located at a position below the sheet transporting region during the maintenance operation.

In the above-described embodiments, an ink jet printer is adopted, but a fluid ejecting apparatus for ejecting a fluid other than ink or a fluid container for storing the fluid may be adopted. Various fluid ejecting apparatuses including a fluid ejecting head for ejecting a minute amount of liquid droplet may be adopted. In addition, the liquid droplet indicates the fluid ejected from the fluid ejecting apparatus, and includes a liquid having a particle shape, a tear shape, or a linear shape. Further, here, the fluid may be a material which can be ejected from the liquid ejecting apparatus.

For example, a liquid-state material may be used, including a liquid-state material such as sol or gel water having a high or low viscosity, a fluid-state material such as an inorganic solvent, an organic solvent, a liquid, a liquid-state resin, or liquid-state metal (metallic melt), and a material in which a functional material having a solid material such as pigment or metal particle is dissolved, dispersed, or mixed with a solvent in addition to a fluid. In addition, ink or liquid crystal described in the embodiments may be exemplified as a typical example of the fluid. Here, the ink indicates general water-based ink, oil-based ink, gel ink, or hot-melt ink which contains various fluid compositions.

As a detailed example of the fluid ejecting apparatus, for example, a liquid crystal display, an EL (electro-luminance) display, a plane-emission display, a fluid ejecting apparatus for ejecting a fluid containing dispersed or melted materials such as an electrode material or a color material used to manufacture a color filter, a fluid ejecting apparatus for ejecting a biological organic material used to manufacture a biochip, a fluid ejecting apparatus for ejecting a fluid as a sample used as a precise pipette, a silkscreen printing apparatus, or a micro dispenser may be used.

In addition, a fluid ejecting apparatus for ejecting lubricant from a pinpoint to a precise machine such as a watch or a camera, a fluid ejecting apparatus for ejecting a transparent resin liquid such as a UV-curing resin onto a substrate in order to form a minute hemispherical lens (optical lens) used for an optical transmission element or the like, or a fluid ejecting apparatus for ejecting an etching liquid such as an acid liquid or an alkali liquid in order to perform etching on a substrate or the like may be adopted. Further, the invention may be applied to any one of the fluid ejecting apparatuses and a fluid container thereof.

What is claimed is:

1. A fluid ejecting apparatus comprising:
a fluid ejecting head which includes a plurality of nozzle rows formed of arranged nozzles ejecting a fluid onto a medium;
a linear fluid absorbing member which extends along the nozzle row, is fewer than the number of nozzle rows, and is disposed between the medium and the fluid ejecting head so as to absorb the fluid; and
a movement mechanism which moves the fluid absorbing member to a position opposite the nozzle row by moving the fluid absorbing member relative to the fluid ejecting head.

2. The fluid ejecting apparatus according to claim 1, wherein the size of the fluid absorbing member is 15 to 50 times the size of the nozzle.

3. The fluid ejecting apparatus according to claim 2, wherein the movement mechanism moves the fluid absorbing member to the position opposite the nozzle at a timing when the medium, onto which the fluid is ejected from the nozzle, is not opposite the nozzle.

4. The fluid ejecting apparatus according to claim 3, wherein the movement mechanism moves the fluid absorbing member relative to the fluid ejecting head so that a difference in the time for moving the fluid absorbing member to the position opposite the respective nozzle rows is minimal.

5. The fluid ejecting apparatus according to claim 4, further comprising:
a second movement mechanism which moves the fluid absorbing member along the extension direction of the nozzle row.

6. The fluid ejecting apparatus according to claim 5, wherein the second movement mechanism includes a detachable rotation portion around which the fluid absorbing member is wound.

7. The fluid ejecting apparatus according to claim 6, wherein the second movement mechanism moves the fluid absorbing member after the fluid is ejected from the other nozzle to the same area of the fluid absorbing member.

8. The fluid ejecting apparatus according to claim 2, wherein the number of the fluid absorbing members is one.
